(19) United States
(12) Patent Application Publication
(10) Pub. No.: US 2022/0027434 A1
(43) Pub. Date: Jan. 27, 2022

(54) PROVIDING RECOMMENDATIONS VIA MATRIX FACTORIZATION

(71) Applicant: International Business Machines Corporation, Armonk, NY (US)

(72) Inventors: Chao Chen, Shanghai (CN); Dong Sheng Li, Shanghai (CN); Stephen MY Chu, Shanghai (CN); Jun Zhu, Shanghai (CN)

(21) Appl. No.: 16/936,850

(22) Filed: Jul. 23, 2020

(51) Int. Cl. G06F 17/16; G06N 20/00; G06N 7/00

(52) U.S. Cl. CPC G06F 17/16; G06N 7/005; G06N 20/00

(57) ABSTRACT

At least one original data matrix is received, wherein the at least one original data matrix includes information of at least one user. At least one submatrix is sampled from the at least one original data matrix, wherein the at least one submatrix includes at least part of information of the at least one user. At least one matrix approximation sub-model is generated for the at least one submatrix based on a trained matrix approximation model, wherein the matrix approximation sub-model captures some preferences of the at least one user.

### BACKGROUND

The present invention relates to data processing, and more specifically, to a method, a system and a program product for recommendation via matrix factorization.

As the development of communication technologies (e.g., 5G mobile networks and smart tablets), large volumes of user behavior data (e.g., transactional data, product reviews data) are continuously generated at ever-increasing scales. The dynamic nature of this stream of data as received urges commercial recommender systems to effectively adapt to novel data patterns in short time scales, otherwise recommendation agents cannot function accurately.

### SUMMARY

This summary is provided to introduce a method, a system and a program product for recommendation via matrix factorization that are further described herein in the detailed description. This summary is not intended to identify key factors or essential features of the claimed subject matter, nor is it intended to be used to limit the scope of the claimed subject matter.

According to one embodiment of the present invention, there is provided a computer-implemented method. According to the method, at least one original data matrix is received by one or more processing units, wherein the at least one original data matrix includes information of at least one user. At least one submatrix is sampled from the at least one original data matrix by the one or more processing units, wherein the at least one submatrix includes at least part of information of the at least one user. At least one matrix approximation sub-model is generated for the at least one submatrix based on a trained matrix approximation model by the one or more processing units, wherein the sub-model captures at least a part of preferences of the at least one user.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts an example flowchart of a method for recommendation via matrix factorization according to an embodiment of the present invention.

FIG. 5 depicts an example diagram for a recommendation system via matrix factorization according to an embodiment of the present invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

As sources of data on users increase, it can be difficult to sift through the large amounts of data to provide tailored content. This may be increasingly necessary as some conventional means of advertising content are more difficult as conventional advertising mediums (e.g., broadcast or cable television, radio, internet ads) are dropping in popularity and/or being blocked. As such, aspects of this disclosure relate to improving a system and method by which sources of data on a user are analyzed so that recommendations may be provided to the user. The recommendation may be for an item, which may be a product that the user may purchase and/or consume (e.g., hosted content such as an article, video, or the like). Aspects of this disclosure may use matrix factorization as described herein to provide recommendation(s) for a user.

It is to be understood that although this disclosure includes a detailed description on cloud computing, implementation of the teachings recited herein are not limited to a cloud computing environment. Rather, aspects of this disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

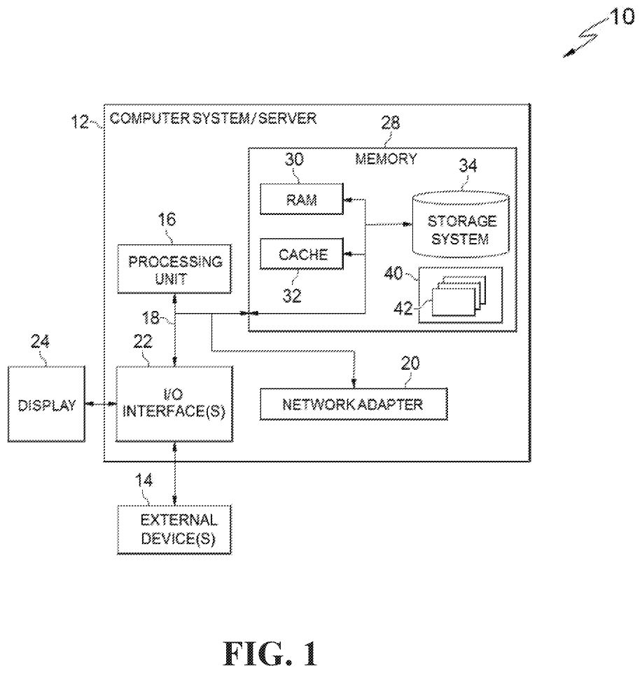

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

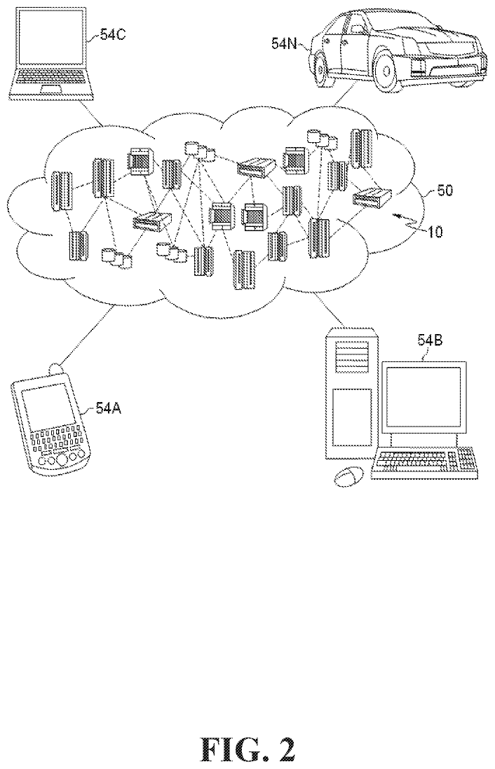

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

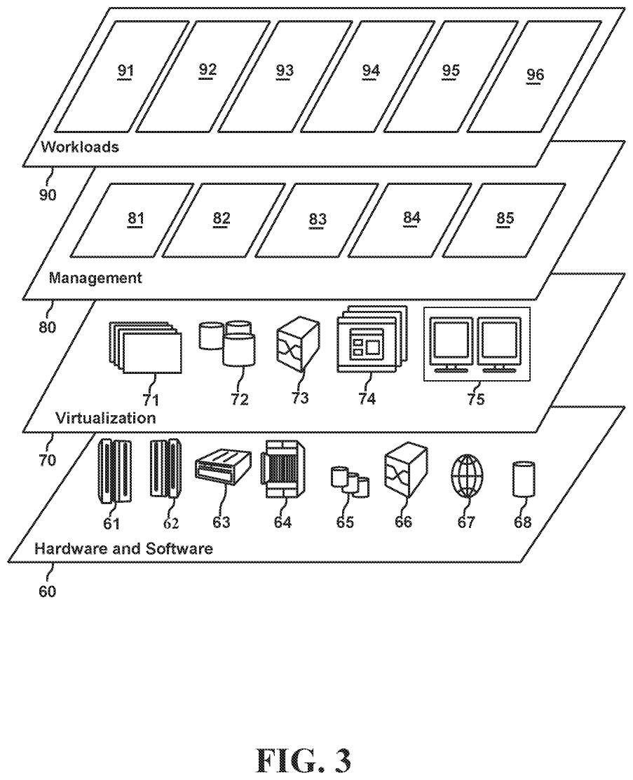

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and item recommending 96.

As discussed in the background part of the present disclosure, the dynamic nature of the streaming data urges commercial recommender systems to effectively adapt to novel data patterns in short time scales. Traditionally, matrix approximation (MA) is a fundamental technique widely used in recommender systems, computer vision and text processing etc., of which the goal is to recover a low-rank matrix R from a few observed entries. For instance, the matrix in recommender system often corresponds to the information of items (columns) by users (rows), and MA based methods are aimed to predict users' missing scores based on a few observed ratings. In one or more embodiments, the score is a value of a preference of a user described hereafter. Matrix approximation often achieves state-of-the-art performance (e.g., Netflix Prize) with relatively low implementation efforts. The stand-alone MA method directly deals with the whole matrix R, which is to find an approximate solution of the following unconstrained regularized optimization problem:

min∥R−Ũ\tilde{V}∥₂+λ_{U}∥Ũ∥₂+λ_{V}∥\tilde{V}∥₂ (1)

wherein R∈ [symbol] ^{m×n}, Ũ∈ [symbol] ^{m×r}, \tilde{V}∈ [symbol] ^{r×n} and [symbol] is the user-item rating matrix, λ_{U} and λ_{V} are the regularization parameters which help the model from overfitting, the upper case letters R, U, V represent matrices, for matrix R∈ [symbol] ^{m×n} with m users (i.e. rows) and n items (i.e. columns), Rᵢⱼ as the entry in the i-th row and j-th column. Furthermore, if R is of rank-r(i.e., rank(R)=r), the matrix approximation of R could be denoted as \hat{R}=Ũ\tilde{V}, wherein \hat{R} is the estimate of the original rating matrix R and generates the missing values in R, and Ũ is the feature matrix for the users, and \hat{V} is the feature matrix (latent factors) for the items. In addition, ∥R∥₂, ∥R∥_{1,2}, ∥R∥_{*} are defined as Frobenius norm, group sparsity norm, and trace norm, respectively.

The matrix approximation of R can provide a unified and clear interpretation for user/item profiling. However, from the computational perspective, formula (1) is a non-convex fourth-order polynomial optimization problem. Its global optimum cannot be guaranteed, and stochastic gradient descent (SGD) is often adopted. More importantly, how to deal with large-scale data is still a challenge.

Therefore, the present disclosure can provide a method to solve this problem by matrix factorization.

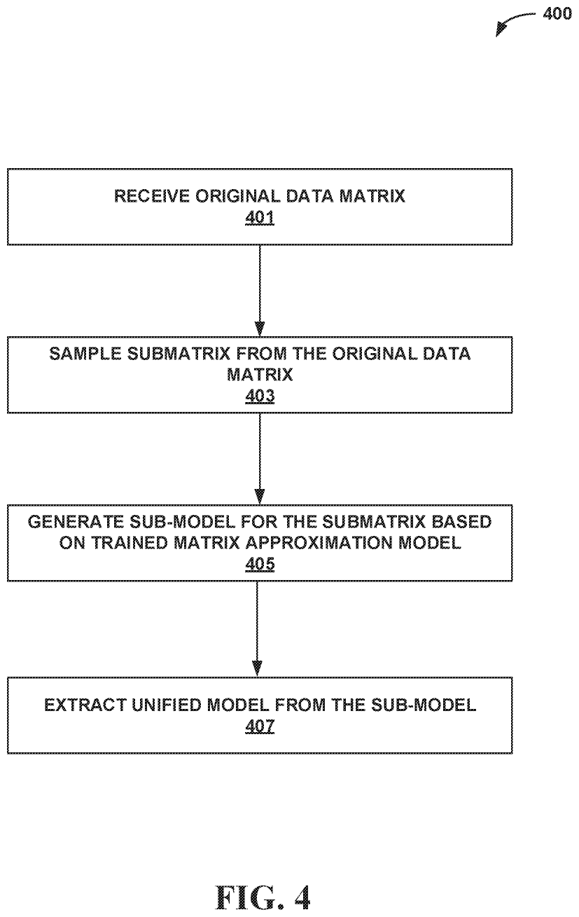

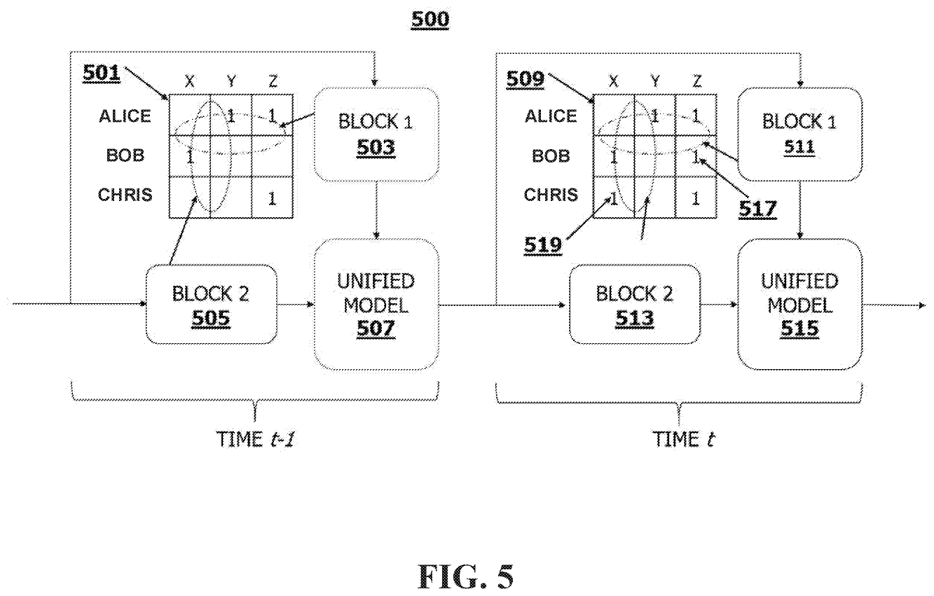

With reference now to FIG. 4, which depicts an example flowchart of a method 400 for recommendation via matrix factorization according to embodiments of the disclosure. The method can be implemented by a recommendation system 500 shown in FIG. 5, which is further described below.

At block 401, the method 400 comprises a step of receiving at least one original data matrix, where the at least one original data matrix includes information of at least one user. The information of at least one user may include one or more scores for at least one item. As used herein, scores may represent one or more recent actions of the user as relates to the at least one item. The item may be something that is provided to the user, such as something that is purchased by the user, something that is provided to the user in response to a query of the user, or the like. For example, the item may be a product that can be sold/purchased online, a service that can be sold/purchased online, a solution for a problem (e.g., a search result for a search query or an answer provided by an expert system), or the like. In one or more embodiments, the recommendation may be implemented online or in a closed information system.

In one or more embodiments, the information may be collected by the system that provides recommendations, though in other embodiments different systems may collect and/or receive the information. In one or more embodiments, the information includes one or more preferences described herein. As noted above, the original data matrix in a recommender system often corresponds to the ratings of items (where the items are arranged by column) by users (where the users are arranged by row), which may reflect one or more actions of the user for each item. For example, actions relating to an item may include reviewing the item, or commenting on the item, buying the item, sharing the item, or the like. Thus, the information may include a recent action of the user that regards at least one item, such that the original data matrix represents a relationship between the at least one user and at least one item.

At block 403, the method 400 comprises a step of sampling at least one submatrix from the at least one original data matrix, where the at least one submatrix includes at least part of the information of the at least one user. Those skilled in the art understand the original data matrix R can be updated according to the time and the user's activity. Therefore, the original data matrix R may be presented as R(t), where t is the time variable (the unit of t may be hour, day or month) and R(t−1) may be a subset of R(t) if new original data are collected at time t. In some embodiments of the disclosure, the sampling comprises randomly sampling the rows and columns of the original data matrix, and the size of the submatrix is significantly smaller than the size of the original data matrix. For instance, at time t, the rows and columns of each submatrix Q(t) are sampled from R(t) uniformly at random. It should be understood that any sampling method which is suitable for the disclosure can be leveraged.

With reference now to block 405, the method 400 comprises a step of generating at least one matrix approximation sub-model. The matrix approximation sub-model may be generated for the at least one submatrix based on a trained matrix approximation model. The sub-model may capture at least some preferences of the at least one user. In one or more embodiments, the preferences may be one of a calculated score or the information collected originally. The preferences may reflect a possibility of interest of the at least user for the at least one item.

The matrix approximation for R may be denoted by \hat{R}, and the submatrix approximation sub-model for the submatrix Q may be denoted by \hat{Q}. The matrix approximation sub-model can capture some preferences of a user (e.g., a preference for a single item). According to one embodiment of the disclosure, the sub-models may be learned in parallel by assuming that the local update information has a sparse structure in the level of group. Moreover, the previously trained matrix approximation model \hat{R}^{(t-1)}=Ũ\tilde{V} may be employed to boost the performance of each individual sub-model \hat{Q}^{t,?}=U^{t,?}V^{t,?} in both efficiency and accuracy. According to one embodiment of the disclosure, the previously trained matrix approximation model is trained based on history information of the user(s). The parameters of the previously trained matrix approximation may be updated and/or improved over time by minimizing the least square loss between the obsolete data and its estimate as noted herein.

Hereinafter how the matrix approximation sub-model for the submatrix is learned is described in detail mathematically.

The method of this disclosure based on submatrix approximation may outperform other traditional algorithms such as regularized singular value decomposition method and its improved version singular value decomposition++(SVD++). Aspects of the disclosure may improve upon conventional methods for at least two reasons: local information of the user is well learned and captured, and the variance of the prediction can be reduced after combining multiple estimates. However, submatrix approximation may raise two concerns: 1) overfitting due to insufficient data from local observations; and 2) incapability of accurately estimating the overall structural information related to all users and items.

Further aspects of this disclosure may reduce or eliminate these concerns. As used herein, [symbol] and [symbol] represent a subset of users and items respectively. Further, Q={Rᵢⱼ|i∈ [symbol] , j∈ [symbol] } is the submatrix of the original data matrix R, and R_{U}={Rᵢⱼ|i∈ [symbol] } represents all the ratings related to user subset [symbol] . Similarly, R_{V}={Rᵢⱼ|i∈ [symbol] } represents all the ratings related to item subgroup [symbol] . Then given a unified model \tilde{R}=Ũ^{(t)}\tilde{V}^{(t)}, for the desired estimation \hat{Q}=U^{(t+1)}V^{(t+1)}, there always exist the following interpolations between past estimate and update factors:

U^{(t+1)}=αŨ^{(t)}+(1−α)U

V^{(t+1)}=β\tilde{V}^{(t)}+(1−β)V (2)

Wherein U, V are update factors for users and items respectively, α and β control the contributions of imported structural features Ũ^{(t)} and \tilde{V}^{(t)}. The unified model is supposed to capture the integrated/overall preferences (properties) of a user (e.g., for a given item).

Based on this, formula (3) and (4) are obtained:

$$\begin{matrix}{min}_{{U}^{( t + 1 )} , {V}^{( t + 1 )}} {‖ Q - {U}^{( t + 1 )} {V}^{( t + 1 )} ‖}_{2} {\leq }^{( a )} {min}_{U , V} ( 1 - α ) ( 1 - β ) {‖ Q - UV ‖}_{2} + αβ {‖ Q - {\tilde{U}}^{( t )} {\tilde{V}}^{( t )} ‖}_{2} + ( 1 - α ) β {‖ Q - U {\tilde{V}}^{( t )} ‖}_{2} + α ( 1 - β ) {‖ Q - {\tilde{U}}^{( t )} V ‖}_{2} & ( 3 ) \\ {\leq }^{( b )} {min}_{U , V} ( 1 - α ) ( 1 - β ) {‖ Q - UV ‖}_{2} + αβ {‖ Q - {\tilde{U}}^{( t )} {\tilde{V}}^{( t )} ‖}_{2} + ( 1 - α ) β {‖ {R}_{V} - U {\tilde{V}}^{( t )} ‖}_{2} + α ( 1 - β ) {‖ {R}_{U} - {\tilde{U}}^{( t )} V ‖}_{2} & ( 4 )\end{matrix}$$

wherein (a) holds due to the convexity of the norm, and (b) holds because of Q [symbol] R_{U}∩R_{V}. According to formula (3), the optimization problem of typical submatrix approximation method relates to the first term, whereas in the rest terms, the global features Ũ^{(t)} and \tilde{V}^{(t)} are involved. Also, data related to user/item subgroup is added to formula (4), such that overfitting problem could be relieved. Specifically, the objective function may be defined as follows:

$${min}_{U , V} {‖ Q - UV ‖}_{2} + {λ}_{U} {‖ U ‖}_{1 , 2} + {λ}_{V} {‖ V ‖}_{1 , 2} + {λ}_{1} {‖ {R}_{U} - {\tilde{U}}^{( t )} V ‖}_{2} + {λ}_{2} {‖ {R}_{V} - U {\tilde{V}}^{( t )} ‖}_{2} \qquad ( 5 )$$

This function may relate to a typical multi-task learning problem, and group-sparsity regularizer ∥⋅∥_{1,2} may be used to induce a sparse representation of local update information. By sharing the latent factor U and V, these group structures can be transferred across data points and correlated variables can be selected jointly. This may result in improving the performance of matrix approximation algorithms by prior work. For example, it has been found that larger λ₁ leads to better results (e.g., regularization parameters which help the model from overfitting include λ_{1,2,U,V}). If considering a fixed stage t, the update of user and item feature vector [symbol] , [symbol] may be written as:

uₖ₊₁^{(t)}=uₖ^{(t)}−ηᵤ[(1−β)∇ᵤf(uₖ^{(t)},vₖ^{(t)})+β∇ᵤf(uₖ^{(t)},\tilde{v}^{(t-1)})] (6)

vₖ₊₁^{(t)}=vₖ^{(t)}−ηᵥ[(1−α)∇ᵥf(uₖ^{(t)},vₖ^{(t)})+α∇ᵥf(ũ^{(t-1)},vₖ^{(t)})] (7)

Wherein ηᵤ and ηᵥ are learning rates, ∇ᵤf(uₖ^{(s)}, \tilde{v}^{(s-1)}) and ∇ᵥf(ũ^{(s-1)}, vₖ^{(s)}) can be viewed as previous gradients of stage (t−1). Therefore, Formula (6) and (7) can be regarded as stochastic gradient with momentum, which uses weighted averaging of previous gradients. Momentum is a standard technique for learning for those skilled in the art, and empirically the training process may be reduced (e.g., reduced from 100 iterations to nearly 40 iteration on MovieLens 10M dataset).

An ensemble strategy is leveraged to reduce recovery error while introducing negligible cost to parallel running time:

$${\dot{R}}_{ij}^{( t )} = {\sum }_{s = 1}^{z} {\hat{Q}}_{ij}^{t , s} / {\sum }_{s = 1}^{z} 1 \vert {\hat{Q}}_{ij}^{t , s} > 0 \vert \qquad ( 8 )$$

wherein 1|\hat{Q}ᵢⱼ^{t,s}>0| is the indicator function which is set to 1 if the prediction is non-trivial, or 0 otherwise. Z is the number of submatrices which are sampled from the original data matrix R at uniformly random, and S is an iterator in the loop. In detail, the submatrix approximation sub-model \hat{Q} is related to variables α, β defined in formula (2), of which the estimation can be calculated by linear regression or support vector machine (SVM), but experimental results have shown the simplest averaging method can always produce satisfied accuracy.

Although how the matrix approximation sub-model for the submatrix is learnt has been explained in detail, it should be clear to those skilled in the art that the detail description is merely for the purpose of illustration and will not adversely limit the scope of the disclosure. Those skilled in the art can leverage any proper learning algorithms for the present disclosure.

Now referring back to FIG. 4, at block 407, the method 400 comprises a step of extracting a unified model from the at least one sub-model, where the unified model presents preferences of the at least one user sub-model. Though block 407 is depicted in the method 400, in some embodiments aspects of the disclosure may provide recommendations via matrix factorization without extracting a unified model from the sub-model.

According to one embodiment of the disclosure, the extracting comprises extracting the unified model based on all the sub-models. According to one embodiment of the disclosure, the extracting comprises a step of generating at least one feature matrix based on the at least one matrix approximation sub-model, wherein the at least one feature matrix represents the preferences of a user for the at least one item; a step of extracting at least one unified vector from the at least one feature matrix; and a step of determining the unified model based on the at least one unified vector.

As noted above, the resulting user features U^{(t+1)} of a sub-model as shown in formula (2), may be the convex combination of global features Ũ^{(t)} and group-sparse update features U. Then those update factors commonly-shared across sub-models could be regarded as replenishment of global factors, while other factors would be sparse and describe local associations in user-item subgroup.

Therefore, one may assume that u-th user's feature matrix Mᵤ∈ [symbol] ^{Q×r} consisting of the resulting user features from q(≤Z) related sub-models (i.e., each row of Mᵤ is the user's preferences from the corresponding sub-model), can be decomposed as Mᵤ=Lᵤ+Sᵤ. In this decomposed form, q is the number of the related matrix approximation sub-models which characterize the target user, r is the size of the user feature vector, and Z is the total number of the matrix approximation sub-model. In some examples, each row of Mᵤ may be similar but not identical to each other. In some examples, the common part is represented by Lᵤ, and Lᵤ to be low-rank (e.g., rank one in one embodiment), while the difference is denoted by Sᵤ, and Sᵤ is sparse.

The low-rank L containing the global structural information and the sparse S including the local information can be recovered by using Robust PCA techniques:

min∥L∥_{*}+λ∥S∥₁s.t., M=L+S (9)

wherein ∥S∥₁ is the [symbol] ₁ norm. This problem can be addressed by existing solvers for those skilled in the art. According to one embodiment, the matrix L may be a rank-1 matrix, of which each row is similar or identical to each other. As such, one row can be used as the feature vector of the user. After performing this procedure for all users and items, the feature vectors of all users (i.e., Ũ^{(t)}) and items (i.e., \tilde{V}^{(t)}) can be achieved to finally constitute the unified model (i.e., \hat{R}=Ũ^{(t)}\tilde{V}^{(t)}).

According to another embodiment of the disclosure, the method further comprises a step of replacing the matrix approximation model with the unified model.

According to another embodiment of the disclosure, the method further comprises a step of generating at least one score for the at least one user for the at least one item based on the at least one sub-model, the score representing an possibility of interest of the at least user for the at least one item.

According to another embodiment of the disclosure, the method further comprises a step of providing an item with a score higher than a threshold for at least one user as a personalized recommendation based on the at least one sub-model. The threshold may be predefined and predetermined (e.g., a threshold of 0.5).

For additional understanding, other embodiments implemented in e-commercial environment will be described in the following paragraphs. Although embodiments are used to explain the recommendation system based on matrix factorization, it should be clear for those skilled in the art that the following description is merely for the purpose of simplifying illustration and will not adversely limit the scope of the disclosure. Those skilled in the art can leverage the present disclosure to any proper kind of recommendation system such as search engines, expert systems etc.

Now referring to FIG. 5, which depicts an example diagram for recommendation system 500 via matrix factorization according to some embodiments. As depicted, recommendation system 500 includes three users (i.e., Alice, Bob, Chris) and three items (i.e., X, Y, Z) with some information which constitutes a 3-by-3 original data matrix 501 (i.e., R). Aspects of the disclosure relate to recovering the missing values in the matrix 501 and deliver the items with high scores as recommendations to the target customer. Generally, a high score may mean high possibility of a user being interested in an item.

Aspects of the disclosure may randomly sample the rows and columns of the matrix 501 at (t−1)-th time period. In this way, a submatrix (e.g., that is significantly smaller than the matrix 501) can be constructed. For example, one of the resulting 2-by-3 submatrix 503, 511 (e.g., block 1) contains the data belonging to the users Alice and Bob, and items X, Y and Z, and submatrix 505, 513 (e.g., block 2) are 3-by-2 matrix. The score “1” stands for the users (Alice or Bob) reviewing/buying/etc. the items (X, Y, Z), while the score “0” or blank stands for the users (Alice or Bob) not yet reviewing/buying/etc. the items (X, Y, Z).

Then at t-th time period, new data arrives in the system. In response to this new data, data matrix 501 is updated to the updated original data matrix 509 which includes the updated data items 517 and 519. The previous (t−1)-th unified model 507 \hat{R}^{(t-1)}=Ũ\tilde{V} which was trained based on the data of (t−1)-th time period may be used. In some examples, both unified features Ũ^{(t)} and \tilde{V}^{(t)} are set to zero at 0-th time period.

In some examples, each user (and item) is encoded into a fixed-length continuous vector, and the user-item score is computed as the dot product of the vectors of the corresponding a pair of user and item. In one or more embodiments, each user and item are characterized by 2-dimension vectors, after which (in the sub-model for the submatrix 511) the user feature matrix Ũ^{(t)} (the item feature \tilde{V}^{(t)}) is a 3-by-2 (2-by-3) matrix.

At t-th time period, Q is denoted by the submatrix 511 that includes users Alice/Bob and items X/Y/Z, and the corresponding sub-models Ũ^{(t)} and \tilde{V}^{(t)} may be developed by combining the unified models Ũ^{(t-1)} and \tilde{V}^{(t-1)} with latent factors U and V as formula (2), where these latent factors (U,V) are optimized by solving formula (5).

Once all submatrix-based sub-models are identified (e.g., or learned, as interchangeably used herein), the score for all users on all items can be estimated by using formula (8). Following this, aspects of the disclosure may provide personalized recommendations for items with respective scores (e.g. 0.8) higher than a predefined threshold (e.g. 0.5) for at least one user.

Each user/item can be described by at least one sub-model. For instance, data for Alice (or item X) may exist in two sub-matrices (i.e., block 1503 and block 2 505). As such, the user Alice (item X) may be described by two different vectors u₁, u₂ (v₁, v₂) which make up a 2-by-2 feature matrix M. Then, by solving formula (9), the common parts of u₁, u₂ (v₁, v₂) may constitute a unified vector that describes (e.g., quantifies a relationship between) the user Alice and/or item X. After performing the procedure in formula (9) to all users and items, the unified user feature matrix Ũ^{(t)} and unified item feature matrix \tilde{V}^{(t)} may be obtained. As such, the unified model 515 (i.e., \hat{R}=Ũ^{(t)}\tilde{V}^{(t)}) may be obtained based on the unified user feature matrix Ũ^{(t)} and unified item feature matrix \tilde{V}^{(t)}.

It should be noted that the processing of recommending via matrix factorization (or achieved by the system for recommending via matrix factorization) according to embodiments of this disclosure could be implemented by computer system/server 12 of FIG. 1.

The present invention may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving at least one original data matrix, the at least one original data matrix including information of at least one user;
sampling at least one submatrix from the at least one original data matrix, wherein the at least one submatrix includes at least part of the information of the at least one user; and
generating at least one matrix approximation sub-model for the at least one submatrix based on a trained matrix approximation model, the matrix approximation sub-model capturing some preferences of the at least one user.

2. The method of claim 1, further comprising extracting a unified model from the at least one sub-model, the unified model presenting preferences of the at least one user.

3. The method of claim 2, further comprising replacing the trained matrix approximation model with the unified model.

4. The method of claim 2, wherein the at least one original data matrix represents a relationship between the at least one user and at least one item, the extracting comprising:
generating at least one feature matrix based on the at least one sub-model, the at least one feature matrix representing the feature of a user for the at least one item;
extracting at least one unified vector from the at least one feature matrix; and
determining the unified model based on the at least one unified vector.

5. The method of claim 4, wherein the information of the at least one user includes a recent action of the user for the at least one item.

6. The method of claim 1, wherein the sampling comprising sampling rows and columns of the original data matrix randomly, wherein the size of the submatrix is smaller than the size of the original data matrix.

7. The method of claim 1, wherein the trained matrix approximation model is previously trained based on history information of the at least one user.

8. The method of claim 7, wherein the at least one item is selected from a group consisting of:
a product;
a service; or
a solution for a problem.

9. The method of claim 1, further comprising generating at least one score for the at least one user for the at least one item based on the at least one sub-model, the score representing a possibility of interest of the at least user for the at least one item.

10. The method of claim 9, further comprising providing an item with a score higher than a threshold for at least one user as a personalized recommendation based on the at least one sub-model.

11. A computer system, comprising:
a processor;
a computer-readable memory coupled to the processor, the memory comprising instructions that when executed by the processor perform actions of:
receiving at least one original data matrix, the at least one original data matrix including information of at least one user;
sampling at least one submatrix from the at least one original data matrix, wherein the at least one submatrix includes at least part of the information of the at least one user; and
generating at least one matrix approximation sub-model for the at least one submatrix based on a trained matrix approximation model, the matrix approximation sub-model capturing some preferences of the at least one user.

12. The system of claim 11, wherein the actions further comprise extracting a unified model from the at least one sub-model, the unified model presenting preferences of the at least one user.

13. The system of claim 12, wherein the actions further replacing the trained matrix approximation model with the unified model.

14. The system of claim 12, wherein the at least one original data matrix represents relationship between the at least one user and at least one item, the extracting comprises:
generating at least one feature matrix based on the at least one sub-model, the at least one feature matrix representing the feature of a user for the at least one item; extracting at least one unified vector from the at least one feature matrix; and
determining the unified model based on the at least one unified vector.

15. The method of claim 14, wherein the at least one item is selected from a group consisting of:
a product;
a service; or
a solution for a problem.

16. The system of claim 11, wherein the sampling comprises:
sampling rows and columns of the original data matrix randomly, wherein the size of the submatrix is smaller than the size of the original data matrix.

17. The system of claim 11, wherein the trained matrix approximation model is previously trained based on history information of the at least one user.

18. The system of claim 11, wherein the actions further comprise generating at least one score for the at least one user for the at least one item based on the at least one sub-model, the score representing a possibility of interest of the at least user for the at least one item.

19. The system of claim 18, wherein the actions further comprise providing an item with a score higher than a threshold for at least one user as personalized recommendation based on the at least one sub-model.

20. A computer program product, comprising a computer readable storage medium having program instructions embodied therewith, the program instructions executable by a processor to cause the processor to:
receiving at least one original data matrix, the at least one original data matrix including information of at least one user;
sampling at least one submatrix from the at least one original data matrix, wherein the at least one submatrix includes at least part of the information of the at least one user; and
generating at least one matrix approximation sub-model for the at least one submatrix based on a trained matrix approximation model, the matrix approximation sub-model capturing some preferences of the at least one user.
